(19) United States
(12) Patent Application Publication
(10) Pub. No.: US 2026/0231864 A1
(43) Pub. Date: Aug. 13, 2026

(54) GRAIN FILL SENSOR AND RELATED DEVICES, SYSTEMS, AND METHODS

(71) Applicant: Ag Leader Technology, Ames, IA (US)

(72) Inventors: Roger Zielke, Huxley, IA (US); Scott Eichhorn, Ames, IA (US); Tony Woodcock, Ames, IA (US); Alan Barry, Nevada, IA (US)

(21) Appl. No.: 19/538,694

(22) Filed: Feb. 12, 2026

Related U.S. Application Data
(60) Provisional application No. 63/757,434, filed on Feb. 12, 2025.

(51) Int. Cl. A01F 12/46; A01D 90/10

(52) U.S. Cl. CPC A01F 12/46; A01D 90/10

(57) ABSTRACT

A grain fill sensing system and method for monitoring grain levels during transfer from a grain cart to a grain trailer. The system includes at least one long-wave infrared (LWIR) sensor positioned to view an interior of a grain trailer and a processor configured to process thermal image data to determine grain fill levels. In some implementations, the system includes cylindrical visual aids (CVAs) mounted within the grain trailer. The processor detects the visibility of the CVAs to determine fill levels and may generate alerts or automatically control grain flow rates to prevent overfilling or spillage. The LWIR sensors may be mounted on the grain cart unload auger or on the grain trailer, and may include gimbal systems for maintaining optimal positioning during operation.

### CROSS-REFERENCE TO RELATED APPLICATION(S)

This application claims the benefit under 35 U.S.C. § 119(e) to U.S. Provisional Application 63/757,434, filed Feb. 12, 2025, and entitled Grain Fill Sensor, which is hereby incorporated herein by reference in its entirety for all purposes.

### TECHNICAL FIELD

The disclosure relates generally to agricultural equipment and grain handling systems, and more particularly to grain fill sensing systems.

### BACKGROUND

In modern agricultural harvesting operations, grain carts serve as mobile grain storage containers used to unload combine harvesters in the field. The grain cart shuttles harvested grain from the combine to a hauling vehicle, typically a truck or wagon, positioned at the field edge for transport on roadways.

Most grain trucks include a tarp system that covers the top of the grain container. The tarp prevents grain from blowing onto roadways during transport and protects the grain from precipitation. Support members span across the grain container to provide a structure for the tarp to traverse. When grain is piled above these tarp supports, the tarp cannot properly close, requiring manual intervention to redistribute the grain—an undesired and time-consuming task.

Conventional grain unloading practices present several challenges. Experienced operators typically open the grain cart gate fully to maximize unloading speed. However, this fast unload rate fills the upper portion of the truck within seconds. Any delay in repositioning the grain cart can result in grain piling above the tarp supports or spilling over the truck sides. This places significant stress on the operator to advance the grain cart at precisely the correct moment. Inexperienced operators frequently cause spillage because they fail to reposition the grain cart in time.

Additional challenges arise when filling the final portion of the truck. The unloading auger must become empty at the moment the truck reaches capacity, as a grain-filled auger may prevent the driveline from turning during the subsequent unload. Operators often partially close the gate when filling the last portion, slowing the unload rate to a manageable level but delaying the return to the combine.

Accordingly, there exists a need for improved systems and methods that can sense grain fill levels in grain trailers and automate aspects of the grain unloading process to reduce operator stress, prevent spillage, and enable less experienced operators to perform grain cart operations effectively.

### BRIEF SUMMARY

A system of one or more computers or computing devices can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

In Example 1, a grain fill sensing system comprising a long-wave infrared (LWIR) sensor configured to be positioned to view at least a portion of an interior of a grain trailer and a processor in communication with the LWIR sensor, the processor configured to process thermal image data from the LWIR sensor to determine a grain fill level within the grain trailer.

Example 2 relates to the grain fill sensing system of any of claims 1 and 3-7, wherein the LWIR sensor comprises an uncooled microbolometer sensor.

Example 3 relates to the grain fill sensing system of any of claims 1-2 and 4-7, wherein the LWIR sensor is configured to be mounted on a grain cart unload auger proximate an unload spout.

Example 4 relates to the grain fill sensing system of any of claims 1-3 and 5-7, wherein the LWIR sensor is configured to be mounted on the grain trailer.

Example 5 relates to the grain fill sensing system of any of claims 1-4 and 6-7, further comprising a gimbal configured to adjust a positioning and rotation of the LWIR sensor.

Example 6 relates to the grain fill sensing system of any of claims 1-5 and 7, further comprising a wireless communication module configured to transmit sensor data or control data between the grain trailer and a grain cart control system.

Example 7 relates to the grain fill sensing system of any of claims 1-6, further comprising a gate controller in communication with the processor, the gate controller configured to automatically adjust a grain flow rate based on the determined grain fill level.

In Example 8, a grain truck fill system comprising at least one long-wave infrared (LWIR) sensor positioned to view at least a portion of an interior of a grain trailer, a processor in communication with the at least one LWIR sensor, and at least one cylindrical visual aid (CVA) mounted within the grain trailer and within a field of view of the at least one LWIR sensor, the CVA comprising a low-emissivity material configured to reflect ambient LWIR radiation.

Example 9 relates to the grain truck fill system of any of claims 8 and 10-16, wherein the CVA comprises a pattern of low-emissivity regions and high-emissivity regions.

Example 10 relates to the grain truck fill system of any of claims 8-9 and 11-16, wherein the CVA is oriented laterally across a width of the grain trailer from a first sidewall to a second sidewall.

Example 11 relates to the grain truck fill system of any of claims 8-10 and 12-16, wherein the CVA is mounted to a tarp support of the grain trailer.

Example 12 relates to the grain truck fill system of any of claims 8-11 and 13-16, wherein the CVA is configured in a V-shape.

Example 13 relates to the grain truck fill system of any of claims 8-12 and 14-16, wherein the CVA is oriented longitudinally along a length of the grain trailer proximate at least one sidewall.

Example 14 relates to the grain truck fill system of any of claims 8-13 and 15-16, wherein the CVA is suspended from an upper structural element of the grain trailer and configured to hang vertically in a free state and to be displaced by grain as grain accumulates within the grain trailer.

Example 15 relates to the grain truck fill system of any of claims 8-14 and 16, wherein the processor is configured to detect a visibility of the CVA in thermal image data from the at least one LWIR sensor and to determine a grain fill level based at least in part on a portion of the CVA that is visible.

Example 16 relates to the grain truck fill system of any of claims 8-15, further comprising a control system configured to generate an alert or automatically adjust grain flow when the grain fill level reaches a predetermined threshold.

In Example 17, a method of monitoring grain fill level in a grain trailer, the method comprising capturing thermal image data of an interior of the grain trailer using at least one long-wave infrared (LWIR) sensor, processing the thermal image data to identify grain within the grain trailer based on thermal emissions, determining a grain fill level based on the processed thermal image data, and generating an output signal indicative of the grain fill level.

Example 18 relates to the method of any of claims 17 and 19-20, further comprising detecting a cylindrical visual aid (CVA) mounted within the grain trailer, wherein determining the grain fill level comprises determining a portion of the CVA that is obscured by grain.

Example 19 relates to the method of any of claims 17-18 and 20, further comprising automatically adjusting a grain unloading rate based on the determined grain fill level.

Example 20 relates to the method of any of claims 17-19, further comprising distinguishing between LWIR emissions directly from grain and LWIR reflections from a trailer surface based on at least one of emissivity differences or polarization characteristics.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a schematic diagram of the system, according to one implementation.

FIG. 2 is a side view of a grain truck, according to one implementation.

FIG. 3 is an exemplary thermal image, according to one implementation.

FIG. 4 shows a thermal image and the polarized image, according to one implementation.

FIG. 5 is a rear view of the system showing cart unloading and sensor field of view, according to one implementation.

FIG. 6 is a side view of the system showing cart unloading and sensor field of view, according to one implementation.

FIG. 7 is a cross-section view of a grain trailer with cylindrical visual aid, according to one implementation.

FIG. 8 is a top view of a grain trailer with a cylindrical visual aid, according to one implementation.

FIG. 9 is a rear view of a grain trailer with cylindrical visual aid and a grain cart unloading, according to one implementation.

FIG. 10 is a rear view of a grain trailer with cylindrical visual aid and a grain cart, according to one implementation.

FIG. 11 is a top view of a grain trailer with a cylindrical visual aid, according to one implementation.

FIG. 12 is a side view of a grain trailer with a cylindrical visual aid, according to one implementation.

FIG. 13 is a top view of a grain trailer with a cylindrical visual aid, according to one implementation.

FIG. 14 is a rear view of a grain trailer with a cylindrical visual aid and grain cart, according to one implementation.

FIG. 15 is a top view of a grain trailer with a cylindrical visual aid and grain cart, according to one implementation.

### DETAILED DESCRIPTION

It is understood by those skilled in the art that a grain cart is a mobile grain storage container used to unload a combine harvester. Grain carts are typically pulled by an agricultural tractor. The term “grain cart” hereinafter refers to the pulling tractor and the grain cart, and combination style vehicles. A grain cart shuttles grain from the combine to another hauling vehicle typically parked at the field edge or other location. The receiving or hauling vehicle is typically a truck or wagon suited to haul grain away from the field on a roadway. The term “truck” or “grain truck” hereinafter refers to the hauling truck or wagon.

Most trucks have a tarp that can be rolled over the top of the grain container. It keeps the grain from blowing onto the roadway and protects the grain from precipitation (e.g. rain, snow, etc.). Support members span across the grain container to provide a structure for the tarp to roll across. If grain is piled above the tarp supports, the tarp may not be able to close. The only resolution is for someone to climb on top of the grain pile and scoop the grain below the tarp support. This is an undesired, cumbersome, and potentially dangerous task that slows down the trucking process. Therefore, grain cart operators try to keep the top of the grain pile at or below the tarp supports.

The normal practice for unloading grain into a truck is to start unloading at one end of the truck and move the grain cart forward (or backward) as the grain piles up in the truck. Experienced grain cart operators will set and leave the gate fully open to hasten the unload. The difficulty is that the fast unload rate fills up the top part of the truck within seconds. A few seconds delay to pull ahead will pile grain above the tarp supports and/or spill grain over the truck sides. This puts stress on the tractor operator to pull ahead at just the right moment. Some operators may spill with a fully open gate because they don't pull the grain cart ahead soon enough, due to inexperience, distraction, or other issue. Because of this, some operators unload at a slower rate, which delays returning to the combine.

Another difficulty is filling the last part of the truck. This may be difficult because the unloading auger needs to become empty the moment the truck becomes completely full. This is because the auger driveline may not be able to turn the auger on for the next unload if it is full of grain. Part of the difficulty is the auger takes several seconds to clean out after the gate is closed. To reduce the difficulty, operators partially close the gate when filling the last part of the truck. This slows the grain unload rate to a manageable level, but it delays returning to the combine.

Disclosed herein is a system that automates part or all the grain cart unload process. The system includes a grain fill sensor that can sense the height and location of the grain in the grain truck while the grain cart unloads into the grain truck. The automated system may use the grain fill sensor to prevent grain spilling and keep the grain level below the tarp supports. The automated system may alarm the grain cart operator during unloading that the truck is full or near full in that location. In response, the operator may move the grain cart to an empty spot or shutoff unloading. The system may also automatically open or close the gate based on the grain fill level in the truck. For example, the system may partially close the gate when the grain fill sensor indicates the grain level is approaching the top of the truck or tarp support.

These features reduce stress on the grain cart operator which makes operating the cart easier and less tiring. It may also enable less skilled operators to operate the grain cart. Enabling less skilled operators enlarges the potential grain cart labor pool. This is a welcome benefit because skilled farm machine operators are hard to find.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent Application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. Pat. No. 12,353,210, issued Jul. 8, 2025, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. Pat. No. 12,268,115, issued Apr. 8, 2025, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. Pat. No. 12,414,505, issued Sep. 16, 2025, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/556,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Pat. No. 12,403,950, issued Sep. 2, 2025, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/766,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensors and Related Devices, Systems, and Methods,” U.S. patent application Ser. No. 19/367,363, filed Oct. 23, 2025, entitled “Agricultural Sprayer Sensor and Related Devices, Systems, and Methods,” U.S. patent application Ser. No. 19/390,280, filed Nov. 14, 2025, entitled “Liquid Product Distribution for Agricultural Spraying Systems and Related Devices and Methods,” U.S. patent application Ser. No. 19/396,047, filed Nov. 20, 2025, entitled “Agricultural Harvesting Systems and Related Devices and Methods,” U.S. patent application Ser. No. 19/396,099, filed Nov. 20, 2025, entitled “Sprayer Nozzle Devices and Related Systems and Methods,” U.S. patent application Ser. No. 19/397,422, filed Nov. 21, 2025, entitled “Systems, Methods, and Devices for Increasing Machine Operating Range,” U.S. patent application Ser. No. 19/408,177, filed Dec. 3, 2025, entitled “Agricultural Guidance and Navigation System and Related Devices and Methods,” U.S. patent application Ser. No. 19/467,539, filed Feb. 2, 2026, entitled “System and Automatic Adjustment to Target Pressure and Related Devices and Methods,” U.S. patent application Ser. No. 19/467,588, filed Feb. 2, 2026, entitled “Harvester Liquid Application System, Devices, and Methods,” U.S. patent application Ser. No. 19/468,722, filed Feb. 3, 2026, entitled “Agricultural Navigation Methods, Devices, and Systems,” U.S. patent application Ser. No. 19/468,873, filed Feb. 3, 2026, entitled “Agricultural Mapping and Related Devices, Systems, and Methods,” U.S. patent application Ser. No. 19/534,324, filed Feb. 9, 2026, entitled “Remote Assistance for Agricultural Display Methods and Related Devices and Systems,” U.S. patent application Ser. No. 19/537,260, filed Feb. 12, 2026, entitled “Agricultural Seed Meter and Related Devices, Systems, and Methods,” U.S. Patent Application 63/760,907, filed Feb. 20, 2025, entitled “Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” U.S. Patent Application 63/906,692, filed Oct. 28, 2025, entitled “Agricultural Alignment System and Related Devices and Methods,” U.S. Patent Application 63/906,646, filed Oct. 28, 2025, entitled “Automated Grail Filling System and Related Devices and Methods,” U.S. Patent Application 63/967,084, filed Jan. 23, 2025, entitled “System and Methods of Row-by-Row Yield Monitoring,” U.S. Patent Application 63/966,976, filed Jan. 23, 2025, entitled “Dispatch Indicator Calibration,” and U.S. Patent Application 63/967,038, filed Jan. 23, 2025, entitled “Grain Fill Sensor and Related Devices, Systems, and Methods,” each of which is incorporated herein by reference.

In an autonomous grain cart, the automated system may control the unloading rate and move the grain cart to an empty spot when the grain fill sensor indicates the current location is full or will be full soon.

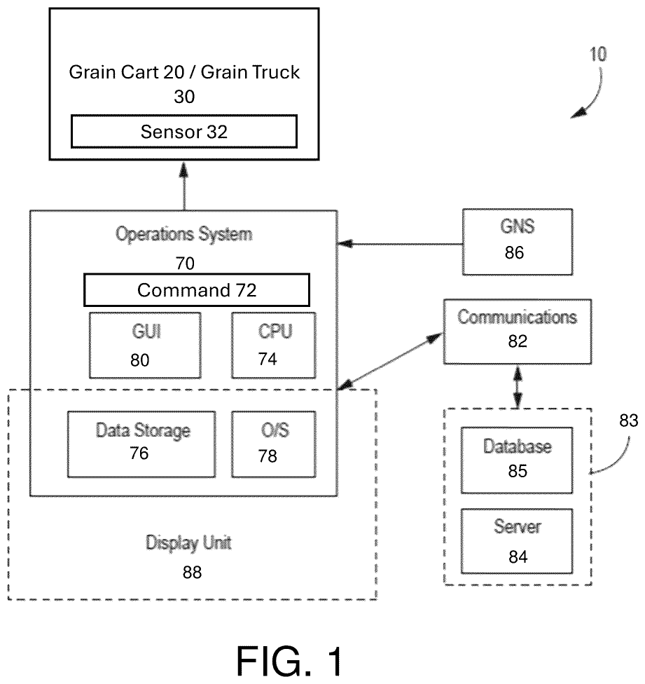

Turning to the figures in more detail, in various implementations, shown for example in FIG. 1, the system 10 utilizes an operations unit 70 in operational communication with the grain cart 20 and/or grain truck 30, a communications component 82, and/or GNSS 86. In certain of these implementations, the operations system 70 is wholly or partially housed in an in-cab display 88, or otherwise in operational communication therewith though the various components described herein can be housed elsewhere, as has been previously described and would be readily appreciated.

In certain implementations, the operations unit 70 has several optional components. In one exemplary implementation shown in FIG. 1, the operations unit 70 comprises a command module 72 and they are configured to execute the various commands and issue electronic communications to the various components to effectuate the steps contemplated by the various methods of operation described herein.

The operations unit 70 according to certain implementations has one or more optional processing and computing components, such as a CPU/processor 74, data storage 76, operating system 78, graphical user interface (GUI) 80, and other computing components necessary for implementing the various technologies disclosed herein. It is appreciated that the various optional system components are in operational communication with one another via wired or wireless connections and are configured to perform the processes and execute the commands described herein.

In certain implementations, like that of FIG. 1, the communications component 82 is configured for the sending and receiving of data for cloud 83 storage and processing, such as to a remote server 84, database 85, and/or other cloud computing components readily understood in the art. Such connections by the communications component 82 can be made wirelessly via understood internet and/or cellular technologies such as Bluetooth, WiFi, LTE, 3G, 4G, or 5G connections and the like. It is understood that in certain implementations, the communications component 82 and/or cloud 83 components comprise encryption or other data privacy components such as hardware, software, and/or firmware security aspects. In various implementations, the operator or enterprise manager or other third parties are able to receive notifications via their mobile phones or other devices.

The various sensors 32, described further herein, according to certain implementations, are configured to electronically report the data it collects to the operations unit 70. Along with the machine operator, other electronic modules and devices would be able to access this data and use it for their calculations, algorithms, programs, etc. Optionally, the recorded data is logged and stored in data storage, either in the operations unit 70 or on the cloud 83. Further, the data can include or be associated with GNS 86 data for spatially logging and visualizing the data.

In various implementations, the operations system 70 receives the raw sensor 32 data, as well as the other optional data discussed herein, then runs it through an algorithm that is calibrated to the sensor 32 or other data sources described herein.

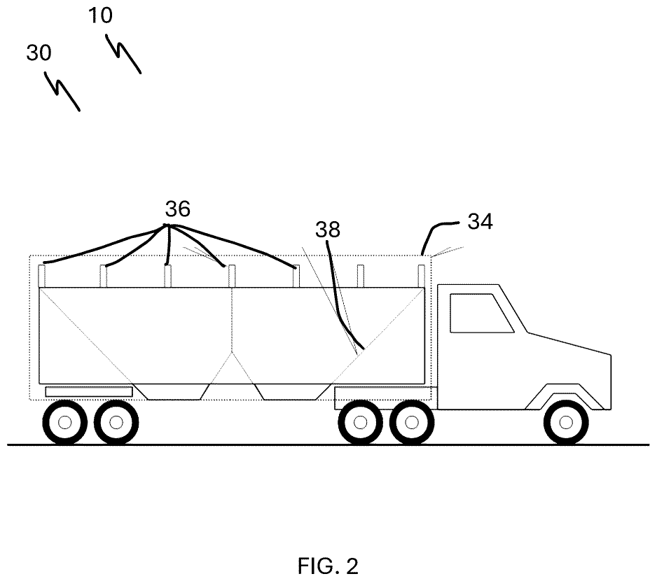

FIG. 2 shows an exemplary grain truck 30, having a trailer 34, trap supports 36, and a interior wall 38.

In various implementations, one or more sensors 32 are used to determine grain height and location, as will be described further herein. In various implementations, the one or more sensors 32 are thermal sensors 32.

One example, of a thermal sensor 32 is a passive, uncooled, long-wave infrared (LWIR) sensor that detects the location and level of grain within the grain truck 30. As would be understood, long-wave infrared is the spectrum of radiation that is emitted by objects in the form of thermal energy. Objects emit long-wave infrared that corresponds to the object's temperature. In one example, the thermal sensor 32 is an uncooled microbolometer sensor 32 that can sense the LWIR emissions of harvested grain as well as other objects.

In various implementations, the LWIR sensor 32 may comprise an uncooled microbolometer sensor 32. An uncooled LWIR microbolometer sensor 32 comprises a thermal sensor 32 with a resistor in every pixel. The microbolometer may be constructed with amorphous silicon (a-Si) or vanadium oxide (VOx), and the microbolometer's resistance changes depending on the incident radiation. As the infrared radiation heats up the resistor structure, the resistance change in each pixel is measured, processed, and used to create an image. Such microbolometer structures may be optimized for sensitivity within wavelengths ranging from approximately 8 to 14 μm.

Emissivity is the measure of how well an object emits their thermal energy. As would be appreciated, the LWIR emissivity of objects depends on their material composition and surface finish. The grain truck 30 is an amalgamation of multiple materials and finishes, including but not limited to, the materials the grain truck 30 is made from and the grain contained within it. For example, grain has a comparatively high emissivity, while smooth aluminum of the interior walls 38 of the truck 30 is quite low. A low emissivity corresponds to a high reflectivity.

During grain trailer 34 fill operations, large clouds of grain dust are generated in and around the trailer. Effective fill level sensors 32 must distinguish the grain level in the trailer through this dust. LWIR is less affected by smoke, dust, and other airborne obscurants than visible light, making LWIR sensors particularly suitable for grain trailer fill operations where substantial grain dust is generated.

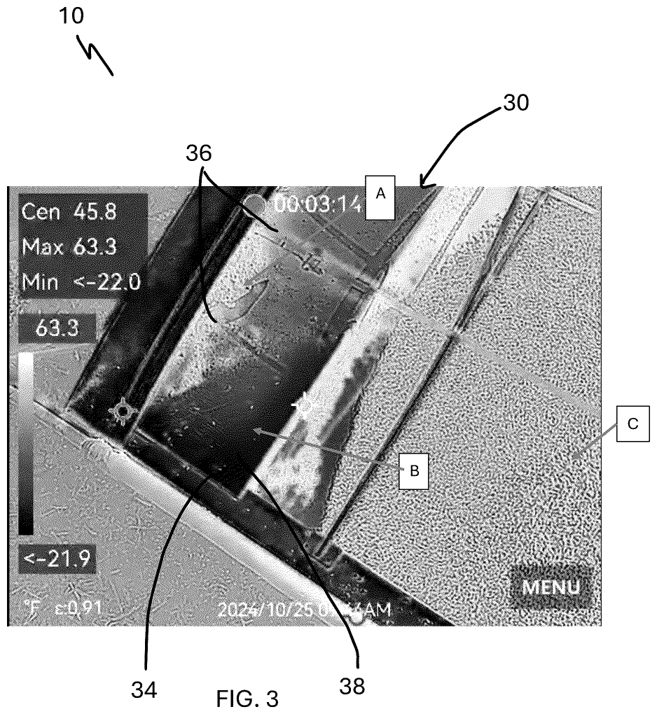

FIG. 3 shows an exemplary image from a LWIR sensor 32. Grain has a high emissivity and emits LWIR radiation in proportion to its temperature (see points A and C). Grain trailers 34 with aluminum beds 38 are very reflective in LWIR. Rather than emitting LWIR radiation in proportion to its temperature, the aluminum panel reflects LWIR from other sources. When viewed from above the panels often reflect the cooler sky before filling with grain, shown at point B. The grain and sky can be easily distinguished in all anticipated harvesting temperature conditions. The atmosphere is a lower-intensity source of LWIR than compared to terrestrial objects. However, the reflective aluminum panels may also reflect the LWIR emitted by the grain making it difficult to distinguish between a reflection of the grain and the truck itself.

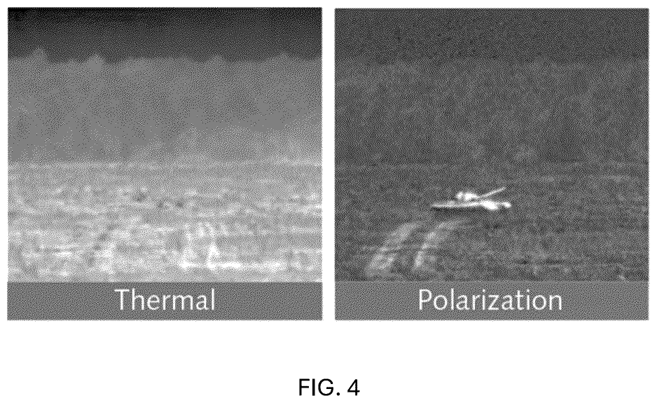

One method to distinguish between a direct emission and a reflection is to additionally measure the polarization of the emission. In some implementations, the polarization characteristics of LWIR light may be analyzed by polarizing each pixel of a quantum well infrared photodetector (QWIP) sensor array. FIG. 4 shows exemplary images from a thermal sensor 32 being polarized (right) and not (left).

Other methods of distinguishing between direct emissions and reflections are described below in the discussion of cylindrical visual aids.

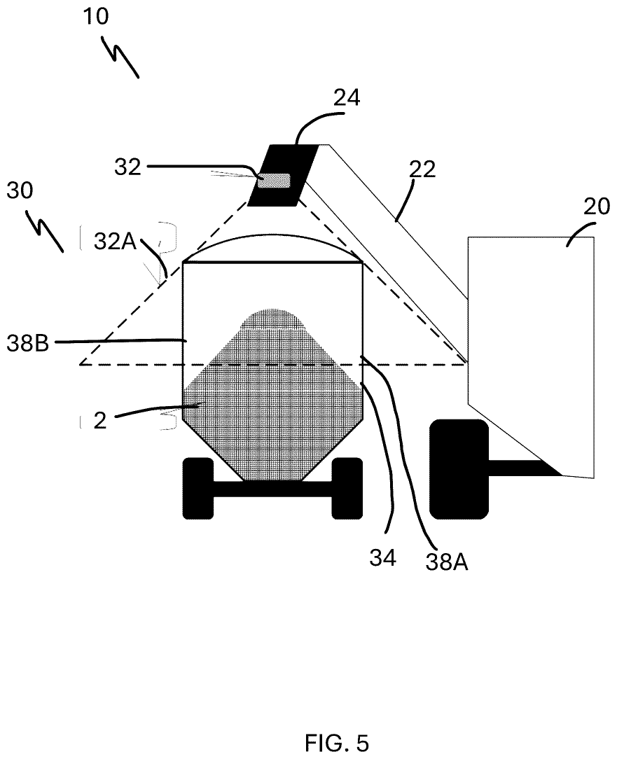

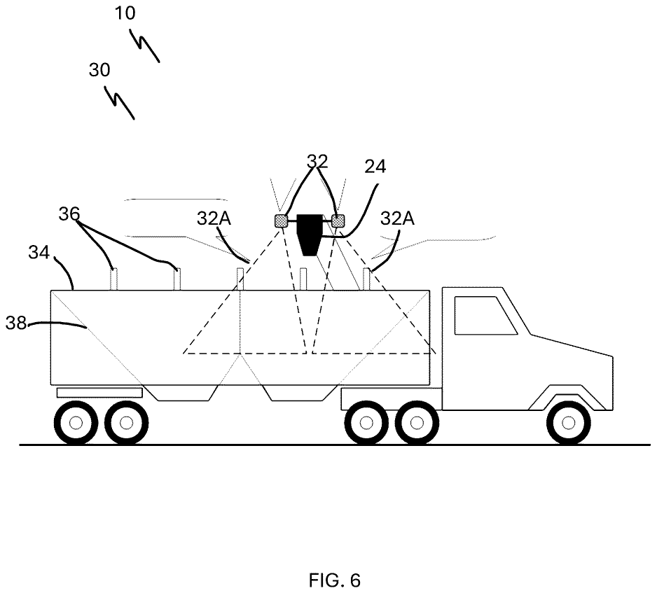

Turning to FIGS. 5 and 6, the thermal sensors 32 may be mounted in the variety of locations. In one implementation, one or more, optionally two, thermal imaging sensors 32 are mounted on the grain cart 20 unload auger 22 near the unload spout 24. The field of view 32A (FoV) of each sensor 32 is directed downward to sense the interior of the grain truck 30 trailer 34 when the grain cart is unloading grain 2 into the truck 30.

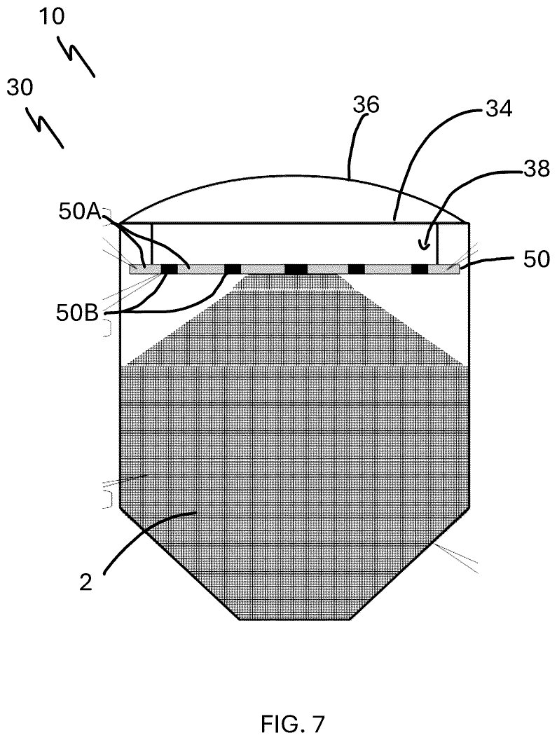

The purpose of the sensor 32 arrangement is to provide a thermal imaging view of the grain truck 30 area surrounding the unload spout 24 of the grain cart 20. This is where the grain 2 pile builds during the unload process. In one implementations, a side-to-side (lateral) view spans from the left sidewall 38B to the right sidewall 38A of the grain truck, shown for example in FIG. 6. In another implementations, a fore-aft (longitudinal) view spans an area about two feet ahead and two feet behind the unload auger 22 spout 24 as measured at the sidewall 38 top of the grain truck 30, shown for example in FIG. 7. This allows the growing grain 2 pile to be sensed and measured by keying on elements in the thermal image. These elements may include grain 2, sidewall interior 38, sloping bottom, tarp supports 36, and visual aid elements inside the grain trailer 34.

As would be understood, the grain truck 30 and grain cart 20 rarely operate on perfectly level and smooth ground. Therefore, the sensor 32 mounting may include passive or active elements (like a gimbal) that change/adjust the positioning and/or rotation of the sensors 32 to keep the field of view 32A of the sensors 32 optimally positioned for sensing the interior 38 of the grain truck 30. The sensor positioning 32 may optionally be adjusted to match the orientation of the grain truck 30 trailer 34 and not just position to horizontally level as would be the case with using a gimbal.

Other implementations may be realized using a sensor 32 mounting that has a more constrained field of view 32A that does not sense the area completely surrounding the unloading grain 2 (grain cart spout 24). For example, one implementation may use a single thermal imaging sensor 32 on the grain cart spout 24. For these and other implementations, the position of the unloading spout 24 may be measured relative to the lateral center of the grain truck 30. Knowing the unload point allows the grain 2 pile height to be estimated using the smaller field of view.

Another implementation uses one or more thermal imaging sensors 32 mounted on the grain truck trailer 34 with a field of view 32A directed into the interior 38 of the grain trailer 34. This truck-mounted system communicates sensor 32 and/or control data through wireless communications to the grain cart 20 where the grain cart 20 control system 70 manages the grain unloading rate and positioning of the grain cart 20 unload spout 24 along the longitudinal axis of the grain trailer 34.

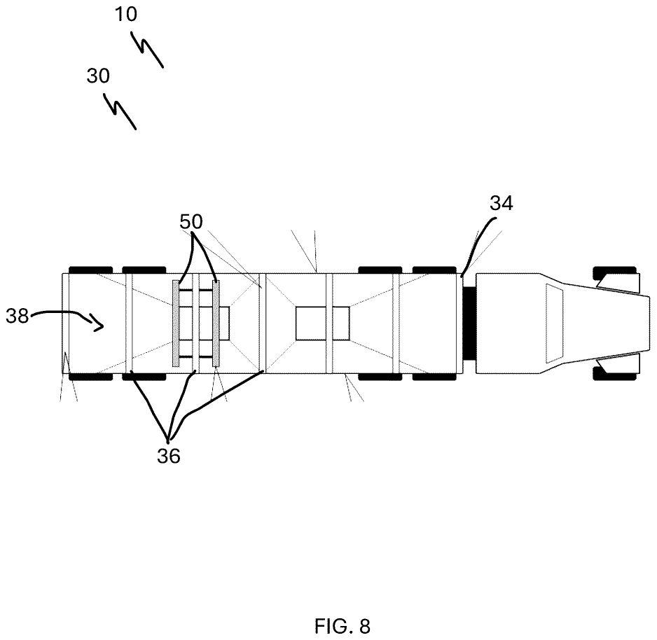

Turning now to FIGS. 8-15, in various implementations, the grain truck 30 includes a cylindrical visual aid 50. There are many ways that the cylindrical visual aid 50 components can be mounted to a grain truck 30.

In one implementations, cylindrical visual aids 50 (CVA) may be mounted in various locations inside the grain trailer 34 to provide the thermal imager and its image processing computer an easily identifiable element. As explained earlier, the cylindrical visual aids 50 are made of a very low emissivity material (e.g. aluminum) and are positioned to provide a reflection of the open sky, which is measured as a very low temperature due to the absence of LWIR. When these CVAs 50 are not covered by grain this creates a low-temperature line in the sensed image that the processing computer is programmed to recognize.

The CVAs 50 may also be made up of a unique pattern (or patterns) of very low 50A and very high 50B emissivity materials. FIG. 7 is an example illustration of this, where the CVA 50 includes a repeating pattern of low 50A and high 50B emissivity materials. In one implementation, the pattern may be created by covering a low-emissivity material (optionally a reflective aluminum pipe) with a high-emissivity material (optionally a tape). The effect is then that the CVA 50 is actually a series of elements that the thermal imager and image processor can detect by its low reflected temperature. As the CVA 50 is covered by grain during the fill process, the imager and processor will detect fewer of the detectable elements (50A, 50B segments) and subsequently be able to measure the grain 2 fill height by the number of elements both detected and not detected.

In various implementations, the method used to suspend the CVA 50 may allow 360 degree angular movement such as a chain or swivel ball, or it may allow movement in one plane only such as a pin hinge. Considerations such as CVA 50 movement during empty trailer transport (free swinging) and potential impact of the CVA 50 with the structure of the trailer 34 may be considered.

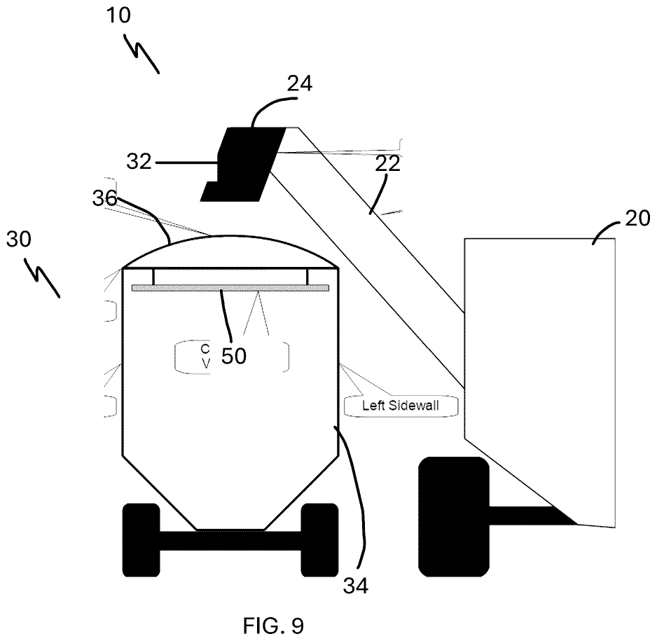

In a lateral installation as shown in FIGS. 8 and 9, the cylindrical visual aid 50 is oriented across the width of the truck 30 inside the trailer 34 (from left sidewall to right sidewall). In the particular implementation shown, the CVA 50 is rigidly mounted to the tarp support 36 such that the CVA 50 is positioned below and to the front and/or rear of the tarp support 36.

In these implementations, the CVA is visible to the thermal imager until the growing grain pile covers the CVA 50. The covering of the CVA 50 is detectable by the image processor as the low temperature reflection of the CVA 50 disappears. The estimation of the grain 2 pile is then determined by the portion of the CVA 50 still visible in the thermal image. When the grain 2 pile estimate reaches a pre-determined height, the grain fill system signals the grain fill control system to move the grain cart or stop the flow of grain into the truck 30. There may be alternative lateral CVAs 50 that provide additionally ways to measure the grain 2 pile.

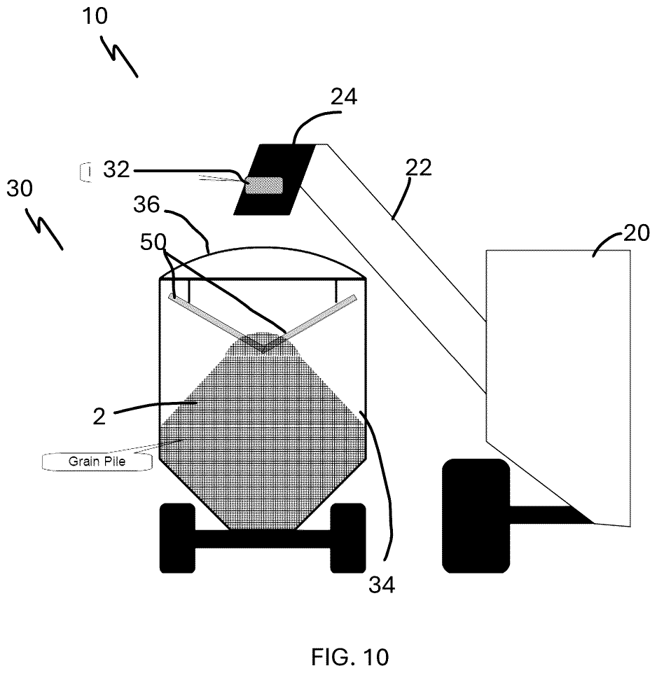

FIG. 10 demonstrates a CVA 50 in a V-shaped configuration. Such a configuration allows the system to detect the growing grain pile earlier than in certain alternative implementation, because the CVA 50 extend down into the interior of the trailer 34.

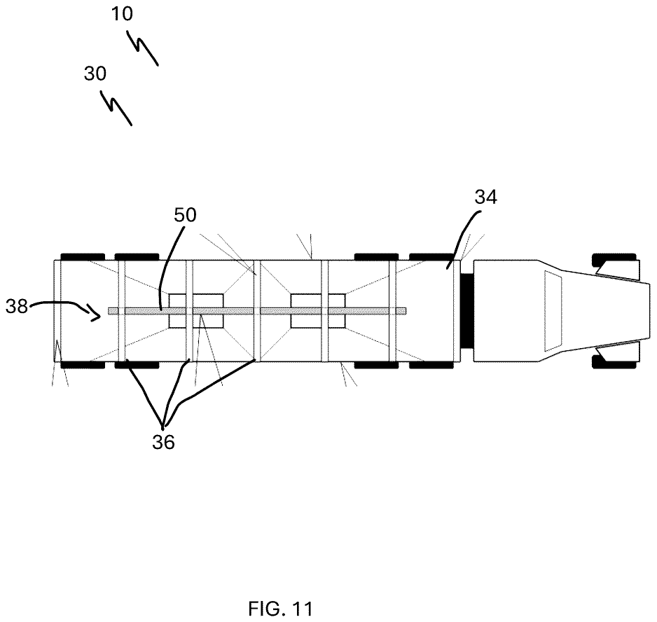

In a further implementation, the CVA 50 is suspended horizontally along the length of the trailer 34 from several grain trailer 34 mounting locations such as multiple tarp supports 36, shown for example in FIG. 11. In this implementation, the CVA 50 has limited movement and does not react to the flow of 2 grain as easily as in certain alternative implementation. Grain 2 will flow at the angle of repose until a section of the CVA 50 becomes obscured by the grain 2 pile in the sensor 32 image. Because the CVA 50 is positioned lengthwise with the grain trailer 34 the image can be used to indicate to the operator filling the grain trailer 34 that the fill auger 22 needs to be repositioned to fully fill the trailer 34 bins without over filling one area. The mounting method used in this iteration can be flexible (such as a chain or cable) or ridged (such as clamps and ridged spacers).

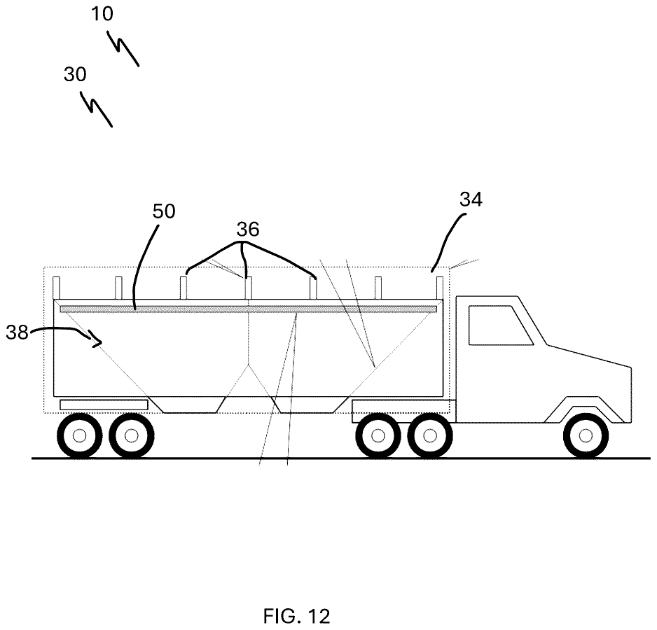

In another exemplary implementation, shown in FIG. 12, the CVA 50 has a longitudinal installation. The longitudinal CVAs 50 are placed near the top of the inside of the grain trailer 34 near the right and left sidewalls. They may be continuous (as shown) or a series. As the grain pile grows and reaches the top of the truck 30, the longitudinal CVAs 50 will be covered when the edge of the pile approaches the top of the sidewall. When the processor 74/operations system 70 no longer detects the CVAs 50 in the thermal image the operations system 70 informs the display 88 and/or control system 72 to stop the grain flow or move the grain unload position to stop the pile growth before spillage occurs. The longitudinal CVAs 50 may have a variety of configurations.

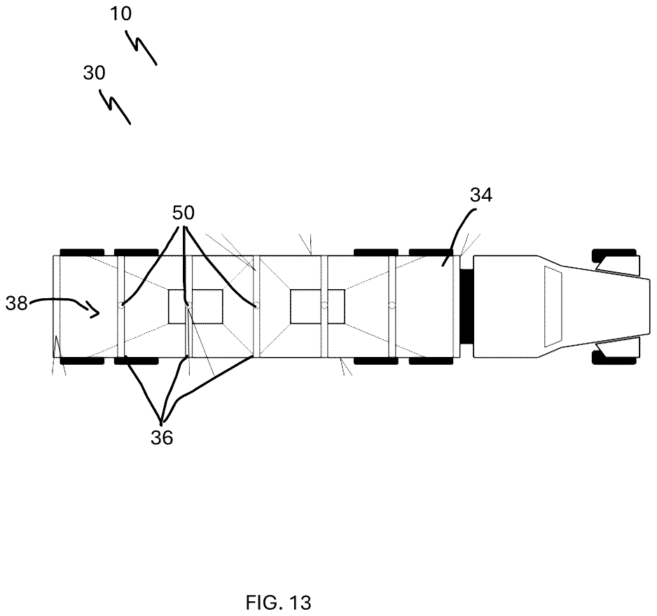

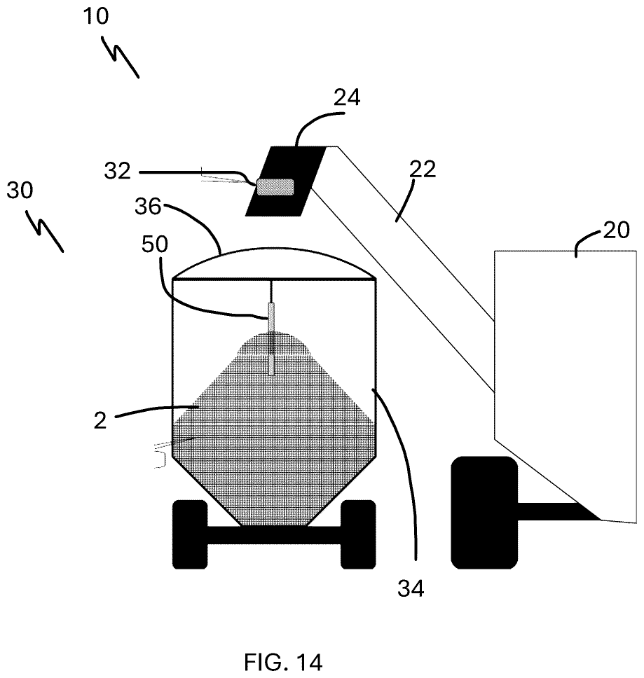

A further alternative implementations, includes suspension of the CVA 50 from an upper structural element of the grain trailer 34 such as an arc shaped tarp support 36, shown in FIGS. 13 and 14. In a free state, the CVA 50 will hang vertically. As grain flows from the delivery system (auger 22 and spout 24) into the trailer 34 the pile 2 will build and slide with the angle of repose of the grain. As that happens the CVA 50 will be pushed away from its free hanging position by the force of the grain as it slides at its angle of repose. At some point, the grain pile will build up around the free end of the CVA 50 and it will cease to move with the grain flow. The angle it hangs at can be measured in the sensor 32 image and used to compute the volume of grain in the trailer 34 bin. As the grain continues to fill the trailer 34 bin, the CVA 50 will appear to get shorter in the sensor 32 image until it disappears, or the sensor 32 image indicates the trailer 34 bin has reached full capacity.

Yet another way to position the CVA 50 in a grain trailer is to manufacture a structure shaped like an “X” and positioned in the view of the sensor 32 so the reflective image is covered by the grain flow as the grain trailer is filled. Because the X shaped CVA 50 will have multiple mounting locations and has a self-supporting structure, grain flow will not affect its position in the view of the sensor 32. Grain will not pile on horizontal surfaces causing cleanout issues and the front to rear fill positioning advantages described in elsewhere herein are maintained. Attaching the CVA 50 to the trailer can be similar to other implementations using either a free hanging chain or cable, or a ridged mount such as a clamp.

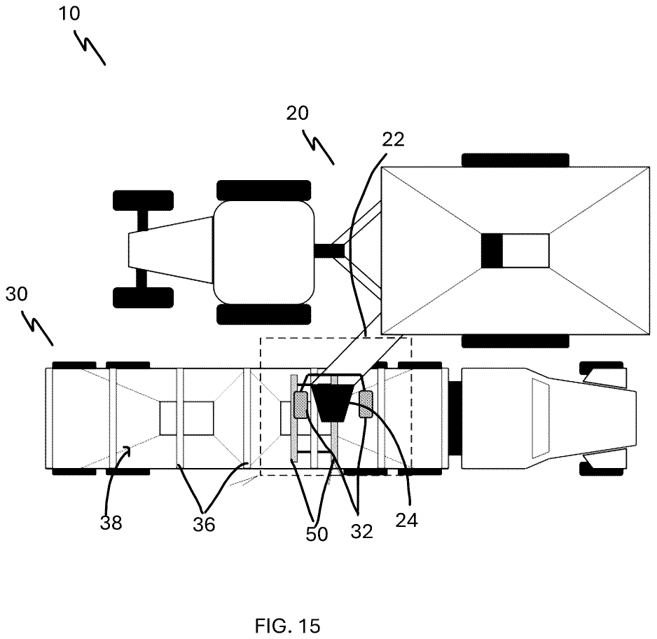

Additional examples of CVA mounting positions can be seen in FIG. 15.

Although the disclosure has been described with references to various embodiments, persons skilled in the art will recognize that changes may be made in form and detail without departing from the spirit and scope of this disclosure.

What is claimed is:

1. A grain fill sensing system comprising:
(a) a long-wave infrared (LWIR) sensor configured to be positioned to view at least a portion of an interior of a grain trailer; and
(b) a processor in communication with the LWIR sensor, the processor configured to process thermal image data from the LWIR sensor to determine a grain fill level within the grain trailer.

2. The grain fill sensing system of claim 1, wherein the LWIR sensor comprises an uncooled microbolometer sensor.

3. The grain fill sensing system of claim 1, wherein the LWIR sensor is configured to be mounted on a grain cart unload auger proximate an unload spout.

4. The grain fill sensing system of claim 1, wherein the LWIR sensor is configured to be mounted on the grain trailer.

5. The grain fill sensing system of claim 1, further comprising a gimbal configured to adjust a positioning and rotation of the LWIR sensor.

6. The grain fill sensing system of claim 1, further comprising a wireless communication module configured to transmit sensor data or control data between the grain trailer and a grain cart control system.

7. The grain fill sensing system of claim 1, further comprising a gate controller in communication with the processor, the gate controller configured to automatically adjust a grain flow rate based on the determined grain fill level.

8. A grain truck fill system comprising:
(a) at least one long-wave infrared (LWIR) sensor positioned to view at least a portion of an interior of a grain trailer;
(b) a processor in communication with the at least one LWIR sensor; and
(c) at least one cylindrical visual aid (CVA) mounted within the grain trailer and within a field of view of the at least one LWIR sensor, the CVA comprising a low-emissivity material configured to reflect ambient LWIR radiation.

9. The grain truck fill system of claim 8, wherein the CVA comprises a pattern of low-emissivity regions and high-emissivity regions.

10. The grain truck fill system of claim 8, wherein the CVA is oriented laterally across a width of the grain trailer from a first sidewall to a second sidewall.

11. The grain truck fill system of claim 8, wherein the CVA is mounted to a tarp support of the grain trailer.

12. The grain truck fill system of claim 8, wherein the CVA is configured in a V-shape.

13. The grain truck fill system of claim 8, wherein the CVA is oriented longitudinally along a length of the grain trailer proximate at least one sidewall.

14. The grain truck fill system of claim 8, wherein the CVA is suspended from an upper structural element of the grain trailer and configured to hang vertically in a free state and to be displaced by grain as grain accumulates within the grain trailer.

15. The grain truck fill system of claim 8, wherein the processor is configured to detect a visibility of the CVA in thermal image data from the at least one LWIR sensor and to determine a grain fill level based at least in part on a portion of the CVA that is visible.

16. The grain truck fill system of claim 15, further comprising a control system configured to generate an alert or automatically adjust grain flow when the grain fill level reaches a predetermined threshold.

17. A method of monitoring grain fill level in a grain trailer, the method comprising:
capturing thermal image data of an interior of the grain trailer using at least one long-wave infrared (LWIR) sensor;
processing the thermal image data to identify grain within the grain trailer based on thermal emissions;
determining a grain fill level based on the processed thermal image data; and
generating an output signal indicative of the grain fill level.

18. The method of claim 17, further comprising detecting a cylindrical visual aid (CVA) mounted within the grain trailer, wherein determining the grain fill level comprises determining a portion of the CVA that is obscured by grain.

19. The method of claim 17, further comprising automatically adjusting a grain unloading rate based on the determined grain fill level.

20. The method of claim 17, further comprising distinguishing between LWIR emissions directly from grain and LWIR reflections from a trailer surface based on at least one of emissivity differences or polarization characteristics.
